(19) United States
(12) Patent Application Publication
(10) Pub. No.: US 2011/0222839 A1
(43) Pub. Date: Sep. 15, 2011

(54) VIDEO CONTENT PLAYBACK APPARATUS, CONTROL METHOD, PROGRAM, AND RECORDING MEDIUM

(76) Inventors: Kazuto OHHARA, Osaka (JP); Tadashi Mihashi, Osaka (JP)

(21) Appl. No.: 13/043,164

(22) Filed: Mar. 8, 2011

(30) Foreign Application Priority Data
Mar. 9, 2010 (JP) 2010-051587

(51) Int. Cl. H04N 5/91

(52) U.S. Cl. 386/353; 386/E05.003

(57) ABSTRACT

A decoding control portion of a video content playback apparatus determines, for each of the video contents, whether any delay occurs, based on an amount of delay acquired at the time when the decoding comes to an end relative to a scheduled time concerning the displaying or the decoding of a moving image stream data. The decoding control portion controls a decoding operation executed by a moving image decoding portion so that a video content with no delay is decoded in an ordinary playback mode that decodes the whole input moving image stream data, and a video content with delay is decoded in a slow playback mode that decodes the content by lowering an amount of throughput of decoding processing with per unit time than that of the ordinary playback mode or in a skipping playback mode that decodes only a part of the input moving image stream data.

### CROSS-NOTING PARAGRAPH

This non-provisional application claims priority under 35 U.S.C. §119(a) on Patent Application No. 2010-051587 filed in JAPAN on Mar. 9, 2010, the entire contents of which are hereby incorporated herein by reference.

### FIELD OF THE INVENTION

The present invention relates to a video content playback apparatus that enables selection of a desired video content from a plurality of video contents by displaying a list of thumbnails of the video contents, and to a control method for the apparatus, a program for the method, and a recording medium of the program.

### BACKGROUND OF THE INVENTION

In a recording apparatus such as a recorder that records a video content on a recording medium, one frame of a moving image of each video content has conventionally been shrunk and displayed as a still image that represents the video content to display a list of many video contents. Such an image that represents a video content is generally called “thumbnail”. When a plurality of video contents are recorded on the recording apparatus, the recording apparatus can be adapted to display a list of a plurality of thumbnails on one screen and to cause a user to select a desired video content using the list.

On the background of the recent increases in the capacity of recording medium and the speed of communication line, the amount of video contents that are estimated to be recordable on local recording media and to be accessible through networks is steadily increasing. When video contents have increased as above, displaying thumbnails each as a still image is insufficient to access a desired video content. This is because, when many video contents are recorded, the content of each of the video contents is sometimes grasped before viewing the video content, while no knowledge more than a vague image of each of the video contents is often possessed before viewing the video content and, therefore, it is difficult to judge the content of the video content based only on the displayed information. An example of such a case includes a case when viewing a video content that is privately shot and edited or when viewing a video content that is automatically recorded according to the taste of a user judged from a viewing history or a keyword setting even when the user has not individually made the settings for recording.

In such a case, it is effective to search a target video content viewing a moving image that directly represents the content of each of the video contents in the display of the list in order to efficiently retrieve the target video content. Therefore, it has been proposed to use moving images as the thumbnails. However, it raises a problem that the amount of data to be processed is increased.

To solve this problem, a technique is disclosed according to which a video content selected by a user from the display of the list is reproduced at the same frame rate as that of the ordinary playback of a video image and the rest of the video contents are reproduced in a manner requiring less amount of throughput. For example, Japanese Laid-Open Patent Publication No. 2004-32535 discloses a video image playback apparatus including: a display that has a function of displaying the list of minified images (moving images) of a predetermined number of moving image data of a plurality of moving image data recorded on a recording medium in a predetermined arrangement form; a selection key to select at least one of the predetermined number of minified images displayed on the display; and a control portion that controls the display such that a playback rate (playback frame rate) of the moving image data selected using the selection key becomes higher than that of the moving image data not selected.

However, according to conventional techniques including the technique described in the '535 Publication, a user needs to designate the video contents to be reproduced one by one to display the video contents as video images to be reproduced at the ordinary playback rate and, therefore, the user has the same operational feeling as that in the case where the user reproduces the video contents one by one when their still images are displayed in the list of their thumbnails. Therefore, the conventional techniques raise a problems that the advantage of simultaneous viewing can not be fully utilized even when the list of thumbnails of moving images (that is, moving image thumbnails) are displayed.

### SUMMARY OF THE INVENTION

The object of the present invention is to provide a video content playback apparatus that does not need any operation by a user to reproduce the moving image thumbnails at an ordinary playback rate of the video contents and is able to reproduce and display as many moving image thumbnails as possible using limited resources at the ordinary playback rate when displaying a list of moving image thumbnails of a plurality of video contents, a control method for the apparatus; a program for the method; and a recording medium for the program.

In order to achieve the above object, a first technical means of the present invention is a video content playback apparatus to display a list of moving image thumbnails for a plurality of video contents, comprising a stream processing portion that acquires a moving image stream data and time information indicating a scheduled time concerning displaying or decoding of the moving image stream data from a stream data of the video content whose moving image thumbnail is displayed in a list; a moving image decoding portion that acquires a moving image frame for the moving image thumbnail by decoding the moving image stream data acquired by the stream processing portion, and calculates an amount of delay at the end of decoding with respect to the scheduled time indicated by the time information; a decoding control portion that controls a decoding operation executed by the moving image decoding portion based on the amount of delay; and an image output portion that outputs the moving image frame acquired by the moving image decoding portion while adjusting the outputting based on the time information, wherein the decoding control portion determines whether any delay is existing in each video content based on the amount of delay, and controls the decoding operation executed by the moving image decoding portion in an ordinary playback mode that decodes a whole input moving image stream data for a video content for which it is determined that no delay is existing, and controls the decoding operation executed by the moving image decoding portion in a slow playback mode that decodes with a decoding processing amount per unit time that is lower than that of the ordinary playback mode, or in a skipping playback mode that decodes only a part of an input moving image stream data for a video content for which it is determined that any delay is existing.

A second technical means is the video content playback apparatus of the first technical means, further comprising a setting portion that sets a video content to which a decoding process for a moving image thumbnail thereof, is given prior to any of a plurality of video contents, wherein the decoding control portion controls the decoding operation executed by the moving image decoding portion in the ordinary playback mode for the video content that is set to be prioritized by the setting portion regard less of the amount of delay.

A third technical means is the video content playback apparatus, further comprising an audio decoding portion that decodes an audio stream data, wherein the stream processing portion acquires an audio stream data corresponding to the moving image steam data in accordance with the time information of the moving image frame acquired by decoding the moving image stream data on the moving image decoding portion for the video content that is set by the setting portion to be prioritized, and supplies the audio stream data to the audio decoding portion.

A fourth technical means is the video content playback apparatus, wherein the moving image decoding portion changes the time information that corresponds to a moving image stream data to which the decoding process is given, according to a playback mode determined by the decoding control portion or depending on the amount of delay.

A fifth technical means is the video content playback apparatus, wherein the video content playback apparatus executes a playback process for one moving image thumbnail of the plurality of moving image thumbnails to be displayed in the list in ordinary playback synchronizing the playback process with an audio regardless of the amount of delay.

A sixth technical means is a control method in a video content playback apparatus to display a list of moving image thumbnails for a plurality of video contents, including: an acquiring step of acquiring a moving image stream data and time information indicating a scheduled time concerning displaying or decoding of the moving image stream data from a stream data of the video content whose moving image thumbnail is displayed in a list; a moving image decoding step of acquiring a moving image frame for the moving image thumbnail by decoding the moving image stream data acquired at the acquiring step, and calculating an amount of delay at the end of decoding with respect to the scheduled time indicated by the time information; a decoding control step of controlling the decoding operation at the moving image decoding step based on the amount of delay; and an output step of outputting the moving image frame acquired at the moving image decoding step while adjusting the outputting based on the time information, wherein at the decoding control step, whether any delay is existing is determined in each video content based on the amount of delay, and the decoding operation at the moving image decoding step is controlled in an ordinary playback mode that decodes a whole input moving image stream data for a video content for which it is determined that no delay is existing, and controls the decoding operation at the moving image decoding step in a slow playback mode that decodes with a decoding processing amount per unit time that is lower than that of the ordinary playback mode, or in a skipping playback mode that decodes only a part of an input moving image stream data for a video content for which it is determined that any delay is existing.

A seventh technical means is the control method, further including a setting step of setting a video content to which the decoding process for a moving image thumbnail thereof, is given prior to any of a plurality of video contents, wherein at the decoding control step, the decoding operation at the moving image decoding step is controlled in the ordinary playback mode for a video content that is set to be prioritized at the setting step regard less of the amount of delay.

An eighth technical means is the control method, further including: a step of acquiring an audio stream data corresponding to the moving image steam data in accordance with the time information of the moving image frame acquired by decoding the moving image stream data at the moving image decoding step for the video content that is set at the setting step to be prioritized; and an audio decoding step of decoding the audio stream data.

A ninth technical means is the control method, wherein the moving image decoding step includes a step of changing the time information that corresponds to the moving image stream data to which the decoding process is given, according to a playback mode determined at the decoding control step or depending on the amount of delay.

A tenth technical means is the control method, wherein a playback process for one moving image thumbnail of the plurality of moving image thumbnails to be displayed in the list is executed in ordinary playback synchronizing with an audio regardless of the amount of delay calculated at the calculating step.

An eleventh technical means is a program for executing the control method on a computer.

A twelfth technical means is a recording medium having the program recorded computer-readably thereon.

### BRIEF DESCRIPTION OF THE DRAWINGS

FIG. 1 is a block diagram of an exemplary configuration of a video content playback apparatus according to an embodiment of the present invention;

FIG. 2 is a diagram of an exemplary system configuration to which the video content playback apparatus of FIG. 1 is applied;

FIG. 3 is a schematic diagram of an example of a list display screen of a display in the system of FIG. 2;

FIG. 4 is a diagram of an exemplary transition of an internal state during an operation of the video content playback apparatus of FIG. 1;

FIG. 5 is a flowchart of an example of an operation of the video content playback apparatus of FIG. 1;

FIG. 6 is a diagram of an example of a rewriting process of display time information in the process of FIG. 5;

FIG. 7 is a diagram of an example of a change of the display time information in the video content playback apparatus of FIG. 1;

FIG. 8 is a diagram of an example of the change of the display time information in the video content playback apparatus of FIG. 1;

FIG. 9 is a flowchart of an example of an audio playback process in the video content playback apparatus of FIG. 1;

FIG. 10 is a diagram of examples of the control information processed in the video content playback apparatus of FIG. 1;

FIG. 11 is a diagram of an example of a transition of the list display screen according to the control information of FIG. 10; and

FIG. 12 is a diagram of another example of the control information processed in the video content playback apparatus of FIG. 1.

### PREFERRED EMBODIMENTS OF THE INVENTION

A video content playback apparatus according to the present invention is an apparatus capable of displaying a list of moving image thumbnails for a plurality of video contents or outputting the moving image thumbnails to display a list of them. In the former case, in the video content playback apparatus a display is included and in the latter case, to the video content playback apparatus a display is connected as is described in an example below. The present invention will be described, with reference to the accompanying drawings, using an example where the number of stream data of video contents that are simultaneously processed to display a list is four. However, the number of stream data is not limited to this and the effect is achieved with a plurality of stream data.

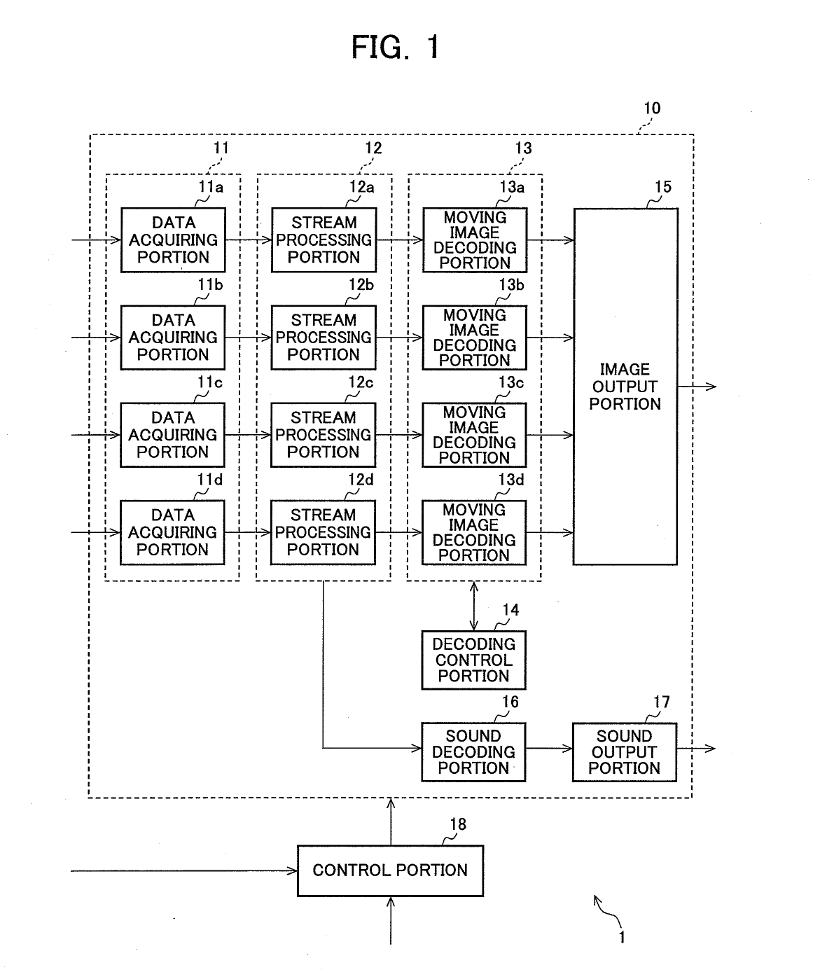

FIG. 1 is a block diagram of an exemplary configuration of a video content playback apparatus according to an embodiment of the present invention. The video content playback apparatus 1 includes a playback control portion 10 and a control portion 18 that controls the playback control portion 10. The playback control portion 10 includes a data acquiring portion 11, a stream processing portion 12, a moving image decoding portion 13, a decoding control portion 14, an image output portion 15, an audio decoding portion 16, and an audio output portion 17.

The portions that are components of the present invention are realized by means of, for example, hardware such as a microprocessor, a memory, a bus, an interface, and peripherals, and software that is executable on the hardware. Apart or a whole of the hardwares may be incorporated as an IC (Integrated Circuit) or an IC chip set and, in this case, the software only has to be stored in the memory. Alternatively, all of the portions that are the components of the present invention may be configured using hardware and, in this case, a part or a whole of the hardwares can also be incorporated as an IC or an IC chip set.

The data acquiring portion 11 acquires stream data of video contents the list of whose moving image thumbnails is displayed by inputting the stream data from the outside of the playback control portion 10 and outputs the stream data to the stream processing portion 12. The data acquiring portion 11 can also be referred to as “data inputting portion”.

The stream processing portion 12 acquires moving image stream data and audio stream data that are multiplexed on the stream data that are input from the data acquiring portion 11 separately pieces from each other based on the analysis of their headers and the results of analysis. The stream processing portion 12 outputs the separated moving image stream data to the moving image decoding portion 13 and the separated audio stream data to the audio decoding portion 16.

The data acquiring portion 11 and the stream processing portion 12 acquire moving image stream data and audio stream data of video contents that are designated by the control portion 18. When the audio stream data are in advance adapted to have two or more audio output paths, the same audio stream data may be acquired as that of the moving image stream data pieces. However, when the audio stream data are not adapted as above, the audio stream data only have to be acquired such that an audio stream data of only one of the plurality of video contents can be reproduced.

The control portion 18 only has to control the data acquiring portion 11, etc., to acquire as many video contents as possible to be displayed according to the display area, the display size of each moving image thumbnail, and other predetermined rules. For example, when the acquisition origin of the video contents is a local recording apparatus or a recording apparatus in a network, the designation only has to be made to extract video contents from video contents that are the default or that are in a folder designated by a user, in predetermined order such as order of descending or ascending file name or order of descending or ascending file capacity and to extract as many video contents as the number of their moving image thumbnails having a default size or a display size designated by the user that can be contained in a display area, or the number that is default or designated by the user (the number and the display size in the display area can also automatically be determined). When an audio stream data is reproduced only for one or a predetermined number of video content(s), for example, the audio stream data can be selected as that to be reproduced that corresponds to the first video content of a plurality of designated video contents or the predetermined number of video contents from the first of a plurality of designated video contents. However, as below, it is preferable to reproduce audio data that corresponds to moving image stream data displayed at the ordinary playback rate. Therefore, it is preferable to preferentially reproduce the audio data of video contents that satisfy the condition that moving images are reproduced at the ordinary playback rate.

A moving image stream data is generally comprised of the coded data for one frame of a moving image. Each frame of the moving image is attached with information on the time at which the frame is to be displayed (display scheduled time) and, when outputs a moving image steam data, the stream processing portion 12 simultaneously acquires and outputs the information that indicates the display scheduled time of the moving image stream data (hereinafter, “display time information”).

The time that is counted by setting zero to the start of a video content or the broadcasting time thereof can be applied to the display scheduled time attached to a stream as the display time information. For example, information referred to as “PTS (Presentation Time Stamp)” that is a time stamp attached to each access unit that is the decoding. Playback unit in MPEG (Moving Picture Experts Group)-2, etc., can be applied to the display time information. The following description will be made on the premise that the display time information that indicates the display scheduled time (that is, playback scheduled time) is used. However, decoding time information that indicates the decoding scheduled time (DTS (Decoding Time Stamp) in an example of MPEG-2) that is the time information used instead of the display time information may be employed and, in this case, the processing can be executed according to an idea that is basically the same as that of the processing described below.

The moving image decoding portion 13 decodes one frame of the moving image from the input moving image stream data. By repeating this, the moving image decoding portion 13 acquires a series of moving image frames for a moving image thumbnail from the moving image stream data. The display time information that is simultaneously input with the moving image stream data designates the timing to display the decoded frame and is output to the image output portion 15 together with the decoded frame.

The moving image decoding portion 13 calculates an amount of delay that represents how long the end of a decoding processing is delayed relative to the display scheduled time indicated by the display time information (a delay time period, or an amount related to the delay time period), and outputs the calculated amount of delay to the decoding control portion 14. The operation of the moving image decoding portion 13 for decoding is changeable according to the control by the decoding control portion 14 and the moving image decoding portion 13 rewrites and outputs the display time information of a frame depending on its decoding operation. The moving image decoding portion 13 calculates relative to the display scheduled time for each video content the amount of delay at the end of the decoding. The amount of delay may also be an amount of delay relative to the decoding scheduled time as above. In this case, a delay of the starting time of the decoding relative to the decoding scheduled time is the amount of delay and the following description can also be used depending on whether the time period required from the decoding to displaying is taken into account or is ignored.

The decoding control portion 14 controls the operation of the moving image decoding portion 13 at the time of processing for displaying a list of the moving image thumbnails based on the amount of delay for each video content. More specifically, the decoding control portion 14 determines whether any delay occurs in the decoding process, based on the amount of delay input from the moving image decoding portion 13. When a delay occurs, the decoding control portion 14 controls the operation of the moving image decoding portion 13 for each vide image content so as to reduce the amount of delay per portion time. The difference between operations of the moving image decoding portion 13 is described as the difference between playback modes. The playback modes in the present invention are modes concerning the playback rate and, therefore, the modes can be adapted to be able to be designated by a user separately from the control in the present invention.

More specifically, the decoding control portion 14 determines whether any delay occurs based on the amount of delay. For a video content that is determined to have no delay, the decoding control portion 14 controls the decoding operation executed by the moving image decoding portion 13 in an ordinary playback mode of decoding all input moving image stream data. The “ordinary playback mode” refers to a playback at the playback rate (frame rate) of the stream data of the video contents.

On the other hand, for the video content that is determined to have a delay, the decoding control portion 14 controls the decoding operation executed by the moving image decoding portion 13 in a slow playback mode or a skipping playback mode. As described below, the slow playback mode or the skipping playback mode executes an operation whose processing load is lighter than that of the ordinary playback mode and, therefore, the amount of delay can be reduced.

The “slow playback mode” refers to a mode of decoding that executes decoding with lower decoding throughput per unit time (with a decoding processing amount per unit time) than that of the ordinary playback mode. The “skipping playback mode” refers to a mode of decoding that decodes only some of the input moving image stream data (that is, some of the frames) and skips the other input data and refers to, for example, a mode that executes decoding and playback at intervals of a predetermined number of frames, at intervals of I frames, or at intervals of I frames of a predetermined number of frames. Whether the slow playback mode or the skipping playback mode is employed for the control only has to be determined in advance by the design. The playback modes may also be adapted to be switched in a stepwise fashion such that the processing amount per unit time is reduced. In this case, the designing can be executed according to the degree of the slow playback or the skipping playback. Therefore, the slow playback mode may be employed first and, when the delay is further significant, the skipping playback mode may then be employed or, in contrast, the skipping playback mode may be employed first and, when the delay is further significant, the slow playback mode may then be employed.

In the exemplary configuration of FIG. 1, an example is taken where the four video contents are processed and, therefore, the data acquiring portion 11, the stream processing portion 12, and the moving image decoding portion 13 are depicted by dividing each of them into four portions, such as data acquiring portions 11a to 11d, stream processing portions 12a to 12d, and moving image decoding portions 13a to 13d, respectively. However, each of the moving image decoding portions 13a to 13d refers to an element of the software and the hardware (decoding hardware, or a CPU that executes a decoding program) that executes the decoding process is basically one piece. Therefore, a hardware resource is not provided in advance for each stream data. This also holds for each of the data acquiring portions 11a to 11d and each of the stream processing portions 12a to 12d. In this manner, the playback control portion 10 executes the acquisition, the separation, the decoding, and the calculation of the amount of delay of the data for each video content. However, in the video content playback apparatus 1 of the present invention, the delay of a stream data basically is changed by the influence of the processing load that includes the status of decoding of other stream data.

In addition to the description of the initial operation of the playback of the moving image thumbnails, it is preferable that all the moving image thumbnails are reproduced at the ordinary playback rate at the starting time of the playback of the moving image thumbnails. However, the initial operation is not limited to this. For example, it may be determined in advance that only one or a predetermined number of video content(s) is/are reproduced at the ordinary playback rate, the first video content (s) of or the predetermined number of video contents from the first of a plurality of the designated video contents may be determined to be reproduced at the ordinary playback rate, and other video contents may be reproduced in the slow playback mode or the skipping playback mode. For the configuration that employs both of the slow playback mode and the skipping playback mode in stepwise manner, the numbers of the slow playback modes and the skipping playback modes may be determined in advance. The number of each of the ordinary playback modes, the slow playback modes, and the skipping playback modes may be determined corresponding to the number of the moving image thumbnails to be displayed, and then the playback may be started. Thereby, occurrence of a delay immediately after the start of the playback can be prevented and the playback modes tend to be converged for each video content.

The image output portion 15 outputs the decoded frames as the moving image thumbnails while adjusting the timings to output the decoded frames based on the display time information. More specifically, the image output portion 15 determines whether each of the input frames after decoded may be displayed based on the display time information, and outputs the frame outside when the frame may be displayed. The determination as to whether the frame may be displayed will be described later. The data format, the color format, etc., of the moving image frame are converted when necessary. For example, when the data of a frame is color space data of Y, U, and V and the display employs a color space of R, G, and B, the color space of the data is converted from YUV into RGB.

The audio decoding portion 16 decodes one frame of the audio from input the audio stream data. By repeating this, the audio decoding portion 16 acquires a series of audio frames to be output together with the moving image thumbnail, from the audio stream data. A set of audio data that is configured by the predetermined number of samples is referred to as “frame”. The audio output portion 17 outputs audio data input from the audio decoding portion 16. The moving image thumbnails can be reproduced without any audio and, therefore, the audio decoding portion 16 and the audio output portion 17 are not indispensable for the playback of the moving image thumbnails.

It is preferable for the video content playback apparatus 1 to include the following setting portion. The setting portion sets the video contents to which a decoding processing for moving image thumbnails is given in priority to other contents of a plurality of moving image contents, that is, the moving image thumbnail to be processed in priority to others of the plurality of moving image thumbnails. The setting portion can be exemplified by the control portion 18 and an operating portion not depicted that accepts the setting.

The priority setting executed here does not include a setting that is executed by the operation of the user such as selecting one from a plurality of thumbnails reproduced and displayed, but strictly includes only a setting executed before the processing for displaying a list of the thumbnail is executed or a setting executed for rules of processing for displaying the rule of which is determined before the processing for display in a list of the thumbnails is executed. The priority setting is executed for one video content based on, for example, control information that is received by the control portion 18 from outside or operation information that is created by an operation of the user in the operating portion and received by the control portion 18. In the following example, only the case where the priority setting is executed for only one video content will be described. However, the priority setting may naturally be executed for the predetermined number of video contents that are fewer than the number of thumbnails that can be displayed, depending on the specification of the video content playback apparatus 1.

The control portion 18 designates one prioritized video content according to the above priority setting and, thereby, the playback control portion 10 is controlled as follows. When the decoding control portion 14 receives from the control portion 18 the designation for the video content that is to be reproduced in priority to others of a plurality of video contents, the decoding control portion 14 controls the decoding operation of the moving image decoding portion 13 such that the video content is reproduced in the ordinary playback mode (that is, at the ordinary playback rate) regardless of the amount of delay (the current amount of delay and the current state) and, of course, regardless of the playback mode currently employed. Thereby, the state can be prevented where delayed video contents are accumulated and many video contents are reproduced in the ordinary playback mode and, accordingly, the amount to be processed exceeds that in the specification. Therefore, the priority setting is advantageous.

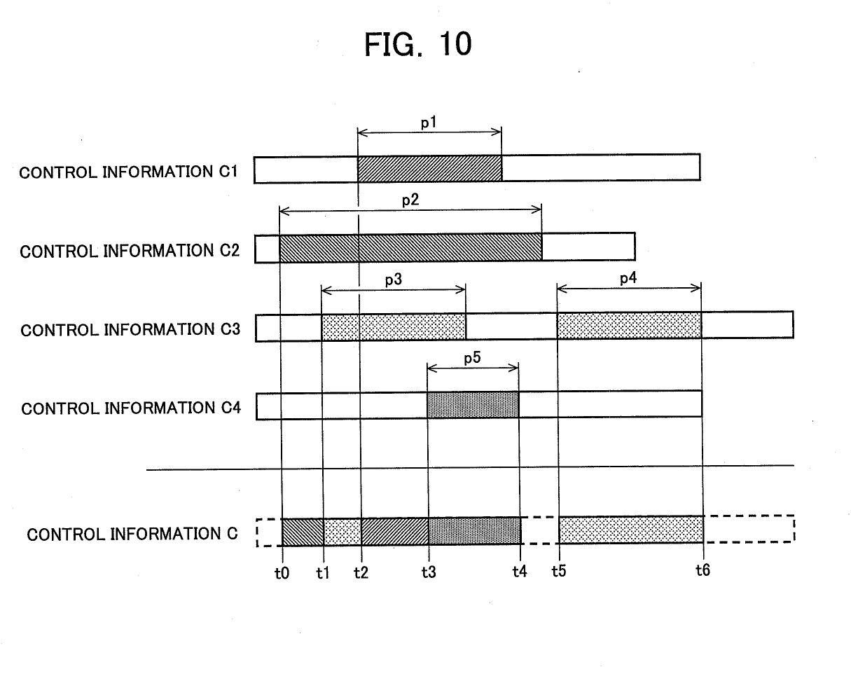

The priority setting using the control information includes a setting that executes a setting according to a preset rule as exemplified with reference to FIG. 10 below. The “preset rule” is a rule that the control portion 18 determines a section designated by a video content distributor and set a priority to the video content for the section. When no control information is supplied from any external information, control information to designate the priority only has to properly be created according to a predetermined rule. The predetermined rule can be, for example, a rule that the length of the playback time period of each video content may be acquired and the priority may be designated in order of length, a rule that the priority may be designated for a specific time period, for example, from top to bottom or from left to right in the arrangement of the thumbnails displayed on a screen, or a rule that the priority may be completely randomly designated.

The priority setting using the operation information may be a setting for a user to designate in advance one rule from a plurality of rules such as, for example, a rule that a thumbnail to be displayed at the top, in the middle, or at the bottom is prioritized. The rule may be adapted to be selectable from any of a plurality of the predetermined rules. In another example of the priority setting using the operation information, a setting by the user to follow an adjustment rule in FIG. 10 below can be employed. The “adjustment rule” is a rule that a video content delayed first is designated to be prioritized and, when next delayed video content occurs, this video content is designated to be prioritized.

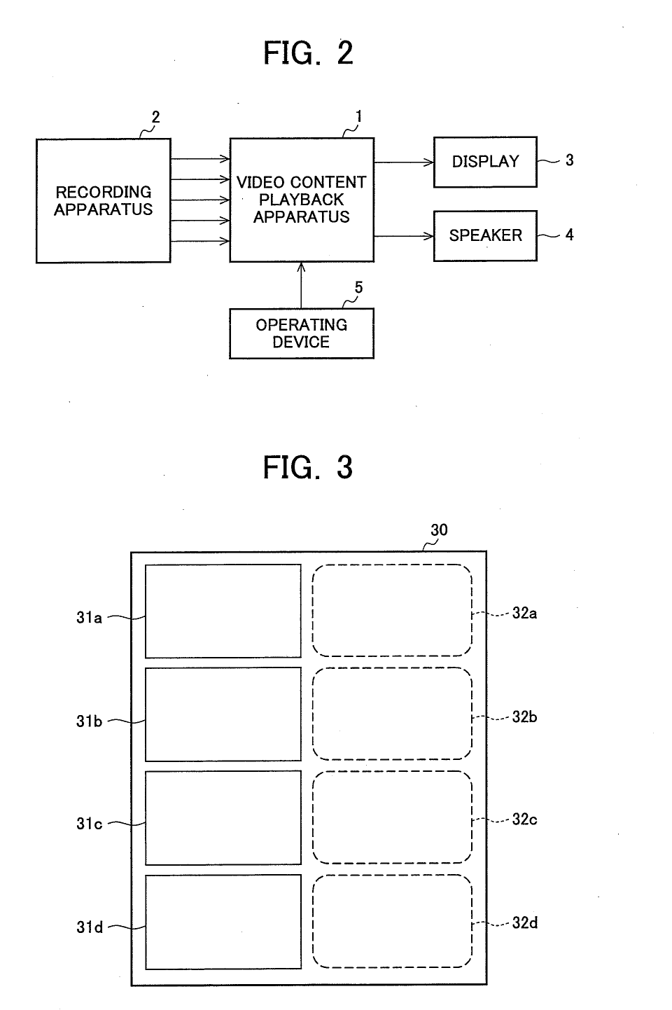

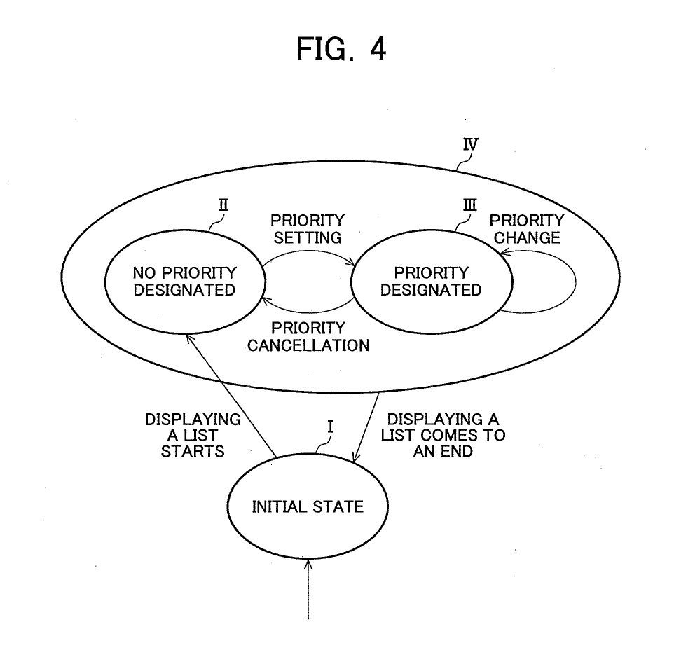

An exemplary system configuration including the video content playback apparatus 1 and a preferred example where the setting portion is provided will be described with reference to FIGS. 2 to 12. FIG. 2 is a diagram of the exemplary system configuration to which the video content playback apparatus of FIG. 1 is applied. FIG. 3 is a schematic diagram of an example of a list display screen of a display in the system of FIG. 2.

A content display system exemplified in FIG. 2 is configured by connecting a recording apparatus 2, an operating device 5 that is an example of the operating portion, a display 3, and a speaker 4 to the video content playback apparatus 1 that can processes a plurality of video contents and can simultaneously display moving image thumbnails. The content display system can be any one of various apparatuses such as, for example, a television device or a mobile telephone. The recording apparatus 2 is configured by a recording medium and a reading apparatus therefor. Moving image thumbnails can be displayed not only for the video contents accumulated in the recording apparatus 2 but also for video contents acquired by communication.

As exemplified in FIG. 3, the display 3 is a displaying portion of a user interface that can display multiple contents using moving image thumbnails. As depicted in FIG. 3, moving image thumbnails 31a to 31d of a plurality of video contents are displayed on the display 3. An audio can be made that is attached as data to one of the video contents. For example, the control portion 18 can read the control information recorded in the recording apparatus 2 and can determine the video content for whose audio is made based on the control information. The control information can be, for example, as above, information designating an audio that corresponds to the first video content of the plurality of video contents or information designating an audio that corresponds to a moving image stream data displayed at the ordinary playback rate. For each of the moving image thumbnails 31a to 31d, text information 32a to 32d attached thereto are also separated from the stream data and displayed and, thereby, the user can easily select a video content that the user more actually desires to view.

FIG. 4 is a diagram of an exemplary transition of an internal state during an operation of the video content playback apparatus of FIG. 1. The state after starting up is an initial state I. When a video content to be processed first is designated and the processing for displaying its moving image thumbnail is started, the internal state transit to a play state II without designation of any priority of list displaying states IV. In the state II, all the video contents are determined not to be prioritized and no audio only has to be output. When the processing amount of the whole system is not much, no calculated amount of delay is present and the playback is still continuously executed in the ordinary playback mode. When the processing amount of the whole system is much, a delay occurs and the playback is executed in the slow playback mode or the skipping playback mode at the step of the occurrence of the delay. At this time, the state transitions to a play state III with priority designation according to the priority setting executed in advance. In the state III: one video content is processed in priority to the next; its moving image thumbnail is reproduced in the ordinary playback mode; and its audio is also reproduced. When the priority designation is cancelled, the state transits to the play state III with no priority designation. Even when the video content with priority designation is changed, the state does not change and remains to be the play state III with the priority designation.

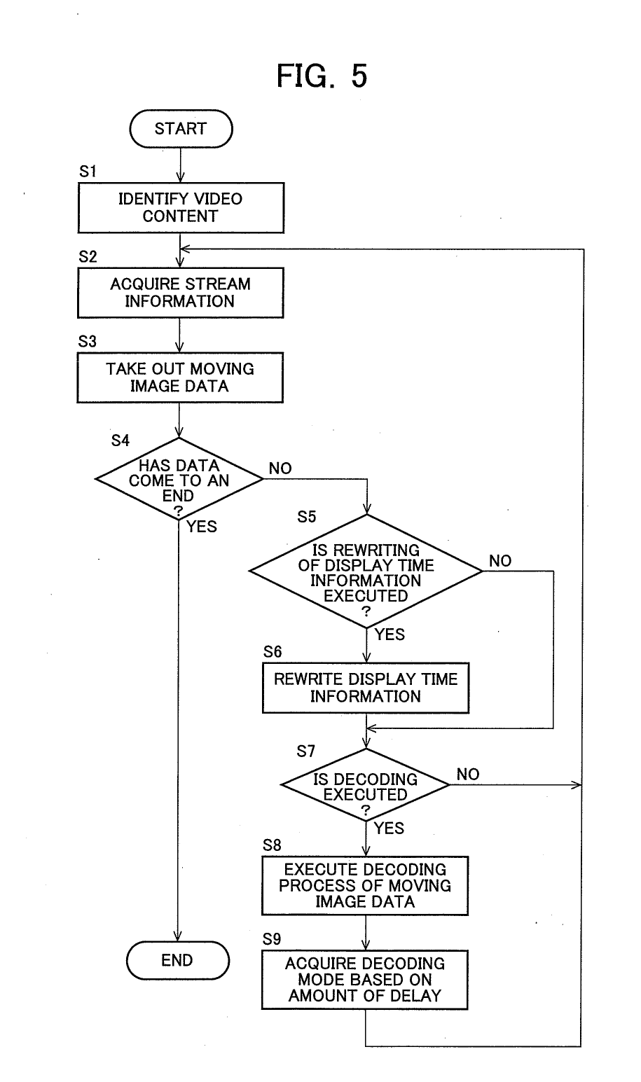

Exemplary operations of the data acquiring portion 11, the stream processing portion 12, and the moving image decoding portion 13 in the play state with no priority designation in FIG. 4 will be described with reference also to FIG. 5. FIG. 5 is a flowchart of an example of an operation of the video content playback apparatus of FIG. 1.

The control portion 18 identifies a video content whose moving image thumbnail is to be reproduced (step S1). For example, the control portion 18 reads and identifies a video content recorded on the recording medium as a file, or the control portion 18 acquires the name of an available video content by accessing a server in the network. The control portion 18 initializes the system time that is the criterion and is retained inside the video content playback apparatus 1 such as the inside of the control portion 18 itself.

Each step of the process described with reference to FIG. 5 will not especially be referred to. However, the step is basically executed by an independent process for each of a plurality of video contents. However, the calculated amount of delay is influenced by other video contents. The identification of the video content whose moving image thumbnail is to be reproduced at step S1 only has to be sequentially started.

According to the control of the control portion 18, the stream processing portion 12 acquires the stream data of a video content through the data acquiring portion 11, analyzes the stream data of the video content, and acquires information on the moving image and the audio stream (step S2). The information that can be acquired at step S2 includes, for a moving image, the resolution, the frame rate, the coding system, the offset value that indicates from which position in the steam data the data for one frame of the moving image can be acquired, and display time information. After the analysis on the stream, the stream processing portion 12 takes out the moving image stream data, processes the display time information that corresponds to the data when necessary, and outputs the display time information to the moving image decoding portion 13 together with the moving image stream data (step S3). The stream processing portion 12 determines whether the data has come to an end (step S4). When the stream processing portion 12 determines that the data piece has come to an end, the process comes to an end. On the other hand, when the stream processing portion 12 determines that the data has not come to an end, the process advances to step S5.

The moving image decoding portion 13 determines whether rewriting of the display time information input is necessary, based on the playback mode that is designated by the decoding control portion 14 (step S5). Only when the moving image decoding portion 13 determines that the rewriting is necessary, the moving image decoding portion 13 executes the rewriting (step S6). The “playback mode” refers to any one operation of the ordinary playback, the slow playback, and the skipping playback as described above. At step S6, the moving image decoding portion 13 changes the display time information (that is, the scheduled display time) that corresponds to the moving image stream data to be processed for decoding, according to the playback mode designated by the decoding control portion 14. In stead of changing the display time information corresponding to the playback mode, the display time information may also be changed corresponding to the amount of delay. In either case, the display time information is changed corresponding to the operating state. The changing process (rewriting process) will be described assuming that the changing process is executed by the moving image decoding portion 13 based on the playback mode. However, the changing process may be executed by the moving image decoding portion 13 based on rewriting control from the decoding control portion 14.

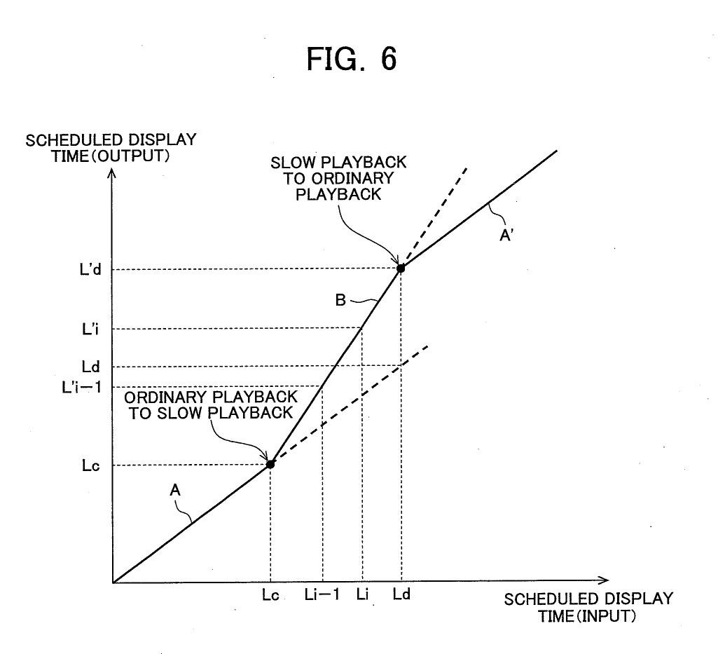

An example of the rewriting process will be described with reference to FIG. 6. FIG. 6 is a diagram of an example of the rewriting process of the display time information in the process of FIG. 5, and is a diagram of an example of the relation between the display time information before and that after the change by the moving image decoding portion 13. Assuming that the video content playback apparatus operates in the ordinary playback mode until the system time reaches the scheduled display time (or the time calculated from the scheduled display time, the same shall apply hereinafter) Lc indicated by the display time information, rewriting of the display time information is not necessary until the system time reaches Lc and the display time information only has to be output as it is.

The description will be made assuming that the operation mode is shifted from the ordinary playback mode to the slow playback mode to playback twice as slowly as usual when the system time reaches the scheduled display time Lc. Assuming that playback which needs 10 seconds to reproduce 100 frames at a playback rate (display rate) of 10 frames/sec is defined as the ordinary playback rate, the doubly slow refers to playback at a rate of five frames/sec, that is, to reproduce 100 frames in 20 seconds.

With the doubly slow playback, the relation between before and after the scheduled display time is changed raises from the straight line A to the straight line B whose steep angle is twice as large as that of the line Band, therefore, the scheduled display time in the display time information is rewritten to follow the line B. For example, in the case where the system times are Li-1 and Li, when the operation mode stays in the ordinary playback mode, frames for the scheduled display times Ii-1 and Li are scheduled to be reproduced. However, because the control is changed to shift the operation mode to the doubly slow playback, the scheduled display times Li-1 and Li are respectively rewritten to Li′-1 and li′ and the rewritten times are output. In the case where the system time reaches Ld when the operation mode is shifted from the slow playback mode to the ordinary playback mode again, the relation of the scheduled display time is changed from the line B to a line A′. The lines A and A′ have the same steep angle while their intercepts are different from each other. Therefore, the display time information needs to be rewritten though the operation mode has returned to the ordinary playback mode. Therefore, for example, the scheduled display time Ld is not output as it is and is rewritten to L′d and is output after rewriting.

Following step S6 in the process of FIG. 5, the moving image decoding portion 13 determines whether the moving image stream data is to be decoded (step S7). When the moving image decoding portion 13 determines that the moving image stream data is not to be decoded, the process returns to step S2. When the moving image decoding portion 13 determines that the moving image stream data is to be decoded, the decoding process is executed (step S8). At step S8, when the operation mode is the ordinary playback mode or the slow playback mode, the decoding is executed as it is. However, when the operation mode is the slow playback mode, the decoding only has to be executed at the rate according to the playback rate. When the operation mode is the skipping playback mode, the moving image stream data is checked before the decoding process is executed therefor and the coding mode thereof is acquired. The “coding mode” refers to a mode of the stream data of one frame of the moving image that can be decoded only with the stream data of the frame (intra) or that uses information on other frames (inter). In the skipping playback mode, for example, only the stream data whose coding mode is the intra are decoded. In the skipping playback mode, playback only has to be executed based on the scheduled display time indicated by the display time information basically similarly to the ordinary playback mode as far as the operation mode has not experienced the slow playback mode before the skipping playback mode. However, even in the skipping playback mode, the playback may be executed by increasing a speed of the thumbnail playback process as far as no delay occurs. On the contrary, the playback may also be executed by decreasing a speed of the thumbnail playback process (that is, the skipping playback and the slow playback) to contribute to solving the delay of other moving image stream data, etc. In either case, the rewriting of the scheduled display time is necessary.

After the decoding process at step S8 comes to an end, the moving image decoding portion 13 acquires the playback mode that is determined based on the amount of delay from the decoding control portion 14 (step S9) and the process returns to step S2. In the next loop, the acquisition of the data at step S2, the decoding process at step S8, etc., are executed based on the acquired playback mode.

The decoding control portion 14 operates independently from the operations presented by the process of FIG. 5 and monitors the amount of delay of the decoding process executed by the moving image decoding portion 13. An occurrence of “delay” only has to be determined when: the system time is acquired; the amount of delay thereof relative to the scheduled display time is calculated; and, for example, the amount of delay exceeds a predetermined threshold value or the amount of delay continues to increase at a specific or a higher rate during a predetermined time period. When the decoding control portion 14 determines that the delay is existing based on the amount of delay, the decoding control portion 14 changes the operation mode of each moving image decoding portion 13, for example, to a mode that imposes a lighter load in order of the ordinary, the slow, and the skipping playback modes. When the decoding control portion 14 determines that no delay occurs and a sufficient capacity is still present for the processing, the decoding control portion 14 changes the operation mode, in contrast, to a mode that imposes a heavier load. This playback mode after the change or the mode still maintained when no delay occurs is delivered to the moving image decoding portion 13 at step S9.

The image output portion 15 adjusts the timing of the output for the display in accordance with the output of the data pieces of the frames decoded and the display time information from the moving image decoding portions 13a to 13d. More specifically, the image output portion 15 acquires the system time and compares the system time with the current display time information of the decoded frame. When the difference between the system time and the scheduled display time indicated by the display time information is equal to or less than a predetermined threshold value, or when the scheduled display time is delayed relative to the system time, the decoded frame is output.

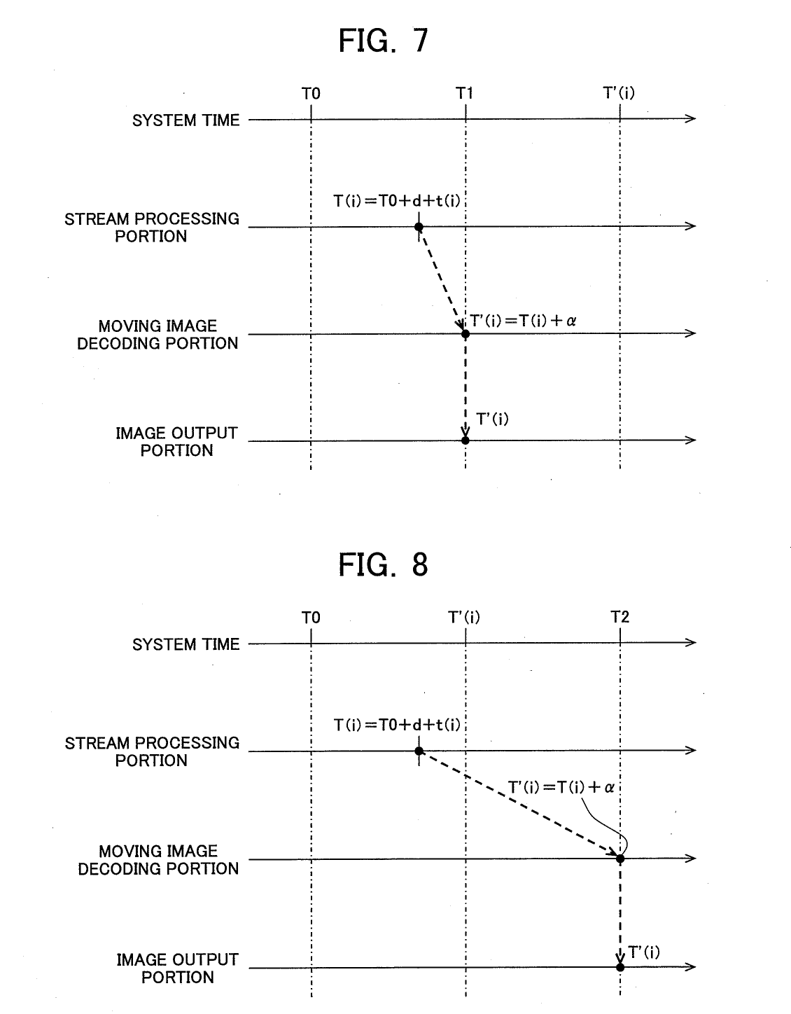

The timing of the output of the decoded frame and the change of the display time information made prior to the output will be described with reference to FIGS. 7 and 8. FIGS. 7 and 8 are diagrams each of an example of the change of the display time information in the video content playback apparatus of FIG. 1. In FIGS. 7 and 8, it is assumed that the control portion 18 initializes the system time to T0 when the playback process is started. The stream processing portion 12 changes the display scheduled time t(i) attached to the stream data to T(i) that is T(i)=T0+d+t(i). This change is a process that corresponds to the process described at step S4 of FIG. 5. “d” is an offset value to delay the display scheduled time by a specific time period, and this offset value d is not employed when the display scheduled time is designated by the broadcasting time in the stream data.

The stream processing portion 12 outputs T(i) to the moving image decoding portion 13. The moving image decoding portion 13 rewrites T(i) to T′(i) that is T′(i)=T(i)+a as described at step S6 of FIG. 5. “α” corresponds to a value expressed by (the scheduled display time after the conversion)−(the scheduled display time before the conversion) described with reference to FIG. 6. Alpha(α) takes the above value in the ordinary playback mode or during the skipping playback executed after the slow playback, becomes zero in other cases, and gradually varies up to the above value during the slow playback.

In the example of FIG. 7, the system time is T1 at the time when the decoding process comes to an end. In this case, the moving image decoding portion 13 outputs “T1−T′(i)” as the amount of delay. In the example of FIG. 7, T′(i) is T′(i)>T1 and no delay occurs. In this case, the moving image decoding portion 13 outputs “T′(i)” as it is as the scheduled display time to the image output portion 15. The image output portion 15 outputs the decoded frame, at the time when the system time becomes T′(i).

In the example of FIG. 8, the system time at the time when the decoding process comes to an end is T2. In this case, the moving image decoding portion 13 outputs “T2−T′(i)” as the amount of delay. In the example of FIG. 8, T′(i) is T′(i)<T2 and, therefore, a delay is existing. In this case, the moving image decoding portion 13 outputs “T′(i)” as it is as the scheduled display time to the image output portion 15. However, the image output portion 15 immediately outputs the decoded frame, at the time when the system time becomes T2, that is, the time when the image output portion 15 receives the decoded frame.

Exemplary playback of an audio in the above example will be described. In the play state III with the priority designation in FIG. 4, one video content is determined to be prioritized and the audio thereof is output. In this case, at step S4 of FIG. 5, not only the moving image stream data but also the audio stream data corresponding thereto are acquired and the audio decoding portion 16 executes the decoding process therefor. The decoding control portion 14 sets the operation mode for processing the video content designated to be prioritized (for example, the operation mode of the moving image decoding portion 13a) to be the ordinary playback mode regardless of the state of other video contents.

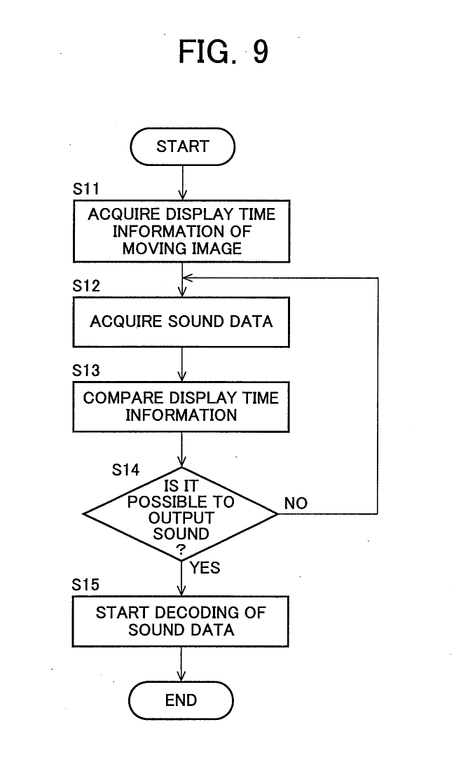

A specific example of an audio playback process executed when the state II with no priority designation transits to the state III with the priority designation in FIG. 4 will be described with reference to FIG. 9. FIG. 9 is a flowchart of an example of the audio playback process in the video content playback apparatus of FIG. 1. The process will be described on the premise that no audio is output in the state II, as in the example taken above.

The control portion 18 acquires the display time information of the moving image frame that is decoded after the designation of the priority (step S11) and inputs the display time information acquired to the stream processing portion 12. The display time information acquired at step S11 is different from the final scheduled display time T′(i) handled by the image output portion 15, and is a value t(i) that is multiplexed on the stream data of the video content, attached to the moving image stream data. This is because the rewriting of the display time information is executed when the playback control is executed as above. The value t(i) is necessary at step S11 and, therefore, the rewriting of the display time information concerning the moving image frame may be executed such that the difference is written to be added leaving t(i), or the difference may be separately retained and t(i) may be acquired by executing the calculations again at step S11.

The stream processing portion 12 acquires the audio stream data through the data acquiring portion 11 (step S12). As above, for the video content that is set to be prioritized, the stream processing portion 12 only has to acquire the audio stream data that corresponds to the moving image stream data and supply the audio stream data to the audio decoding portion 16 according to the display time information t(i) of the moving image frame that is acquired by decoding the moving image stream data by the moving image decoding portion 13.

The scheduled display time indicated by the display time information input is compared to the scheduled display time indicated by the display time information of the acquired audio stream data (step S13). In the case where the rewriting of the display time information concerning the moving image frame is completely executed, when calculation is not executed again at step S11, the difference only has to be stored and the comparison only has to be executed at step S13 by taking the difference into account. The audio stream data of a designated time cannot always be acquired and, therefore, synchronization thereof with the moving image is established at the time of outputting. When the difference between the scheduled display time of the audio stream data and the scheduled display time with respect to the input moving image stream data is equal to or less than a predetermined value, the audio stream data can be output and, when the difference is not equal to or less than the predetermined value, the audio stream data can not be output. The audio stream data that can not be output may be stored until the scheduled display time or may by abandoned. The stream processing portion 12 determines whether the audio can be output based on the above determination criterion (step S14). When the stream processing portion 12 determines that the audio can not be output, the process returns to step S12 and another audio stream data is acquired.

When YES at step S14, that is, the stream processing portion 12 determines that the audio can be output, the stream processing portion 12 gives to the audio decoding portion 16 the audio stream data that is acquired through the data acquiring portion 11. The audio decoding portion 16 starts the decoding process of the audio stream data and outputs the decoded audio data to the audio output portion 17. The audio output portion 17 executes various kind of audio processes as necessary, and outputs the decoded audio data in the state synchronized with the moving image thumbnail based on the scheduled time for adding the stream of each other or information on the time calculated based on the scheduled display time.

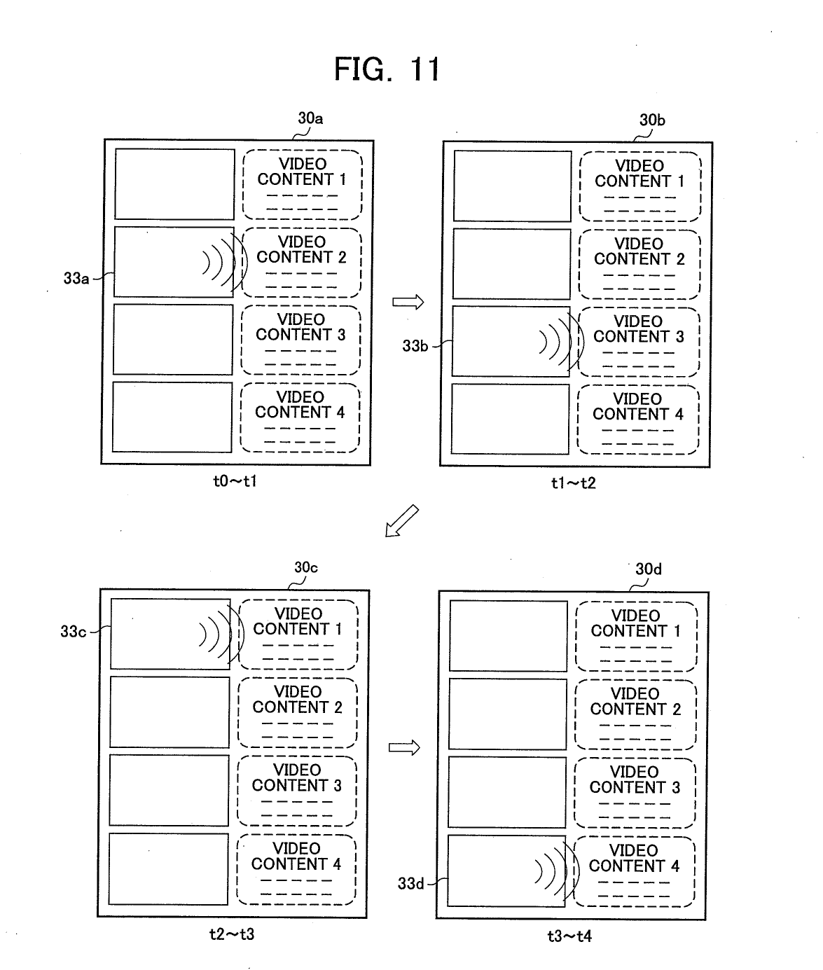

The priority setting by the control information will be described with reference to FIGS. 10 to 12 with a specific example. FIG. 10 is a diagram of examples of the control information processed in the video content playback apparatus of FIG. 1. FIG. 11 is a diagram of an example of a transition of the list display screen according to the pieces of control information of FIG. 10.

The control information handled by the control portion 18 includes information that designates a section of the playback time period of the video content. The section that is designated by the control information is referred to as “exaggeration section”. In an exaggeration section, the control portion 18 controls the playback control portion 10 to reproduce the video content in priority to others at the ordinary playback rate and including audio. The exaggeration section of the control information can be determined by the control portion 18 based on, for example, an a preset rule that a section designated by the distributor as a highlight of the video content is extracted for priority designation of the moving image thumbnail of the video content. Thereby, the intention of the presenter of the video content can be reflected.

When the exaggeration sections that are designated for a plurality of video contents overlap on each other, the control portion 18 adjusts these sections. A rule may be employed as the rule for the adjustment, for example: that the exaggeration sections are sequentially lined up in their time sequence and, thereafter, the length to be prioritized with respect to the overlapping section is determined according to its rate against all the lengths, or that an exaggeration section having a shorter length is more prioritized; or another rule may be employed. It is possible to determine the adjustment rule based on the setting by the user as described above.

In the example of FIG. 10, each control information, C1 to C4, is control information that respectively corresponds to each video content, 1 to 4, and respectively has each exaggeration section, p1, p2, p3 and p4, and p5. In this case, the exaggeration sections overlap on each other and, therefore, for example, as represented by the control information C: the video content 2 is prioritized between t0 and t1; the video content 3 is prioritized between t1 and t2; the video content 1 is prioritized between t2 and t3; and the video content 4 is prioritized between t3 and t4. Thereby, as depicted in FIG. 11, the display screen transits from a screen 30a to a screen 30d. In the screens 30a to 30d of FIG. 11, moving image thumbnails 33a to 33d of the video contents are reproduced in the ordinary playback mode and the audios thereof are also output attached thereto.

As in the example of FIG. 10, a rule can also be employed as the adjustment rule, that a video content that is delayed first is designated to be prioritized and, when next delayed video content occurs, this video content is designate to be prioritized. In the case where this adjustment rule is employed, it is possible to add processing for returning to the control before setting priority by cancelling the priority setting if a specified user operation is accepted or to add processing for automatically setting priority to the other video content if it has an exaggeration section even though the return processing is executed when the specified user operation is accepted, even when a video content enters an exaggeration section that is set in advance according to a stream data. Thereby, not only the intention of the video content provider but also the idea of the user can be reflected.

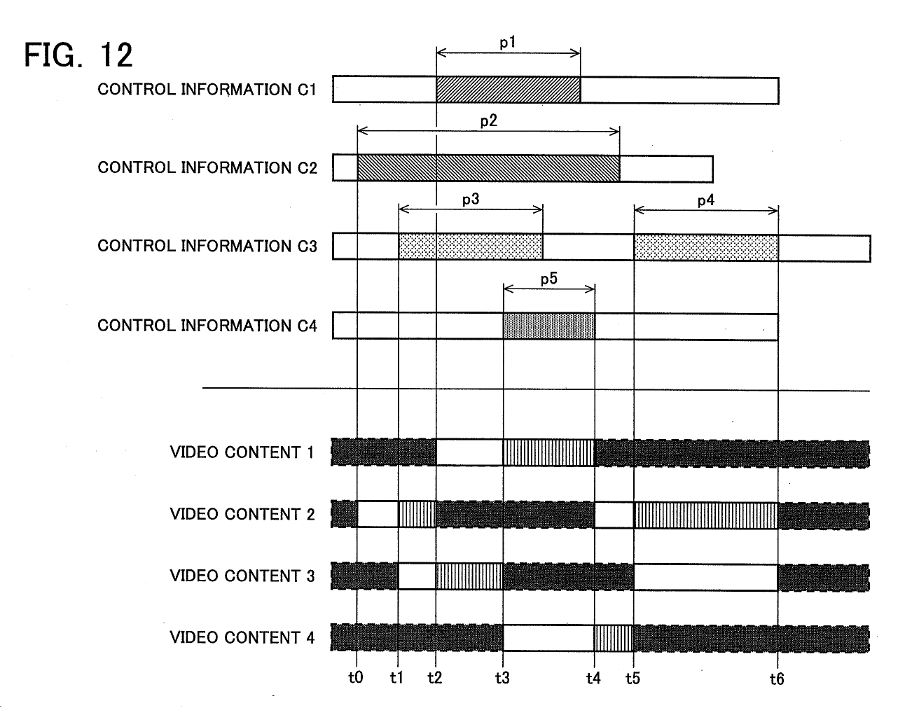

With reference to FIG. 10, the example has been taken where the number of stream data to be reproduced in the ordinary playback mode is controlled to be one by adjusting the exaggeration section. An example where allocation between the slow playback mode and the skipping playback mode is also employed will be described with reference to FIG. 12. FIG. 12 is a diagram of another example of the processing of the control information in the video content playback apparatus of FIG. 1.

In the example of FIG. 12, each control information, C1 to C4, is the control information corresponding to each video content, 1 to 4, respectively, and has each exaggeration section, p1 to p5. In this case, because the exaggeration sections overlap on each other, the control portion 18 adjusts the control information such that ordinary playback is executed as an exaggeration section and, thereafter, the playback mode is shifted to the slow playback mode after moving to another exaggeration section. FIG. 12 depicts the execution of the control according to the control information on the video contents 1 to 4, that is, the controls are executed in the ordinary playback mode for a period of time represented by a colorless section, in the slow playback mode for a period of time represented by a vertical-line-hatched section and in the skipping playback mode for a period of time represented by a black-painted section, respectively. For example, according to the control information of the video content 1, the adjustment is made such that the control is executed in the skipping playback mode before t2 and after t4, in the ordinary playback mode based on the priority designation between t2 and t3, and in the slow playback mode between t3 and t4.

As has been described with reference to FIGS. 1 to 12, it is possible to prevent an overload by controlling the playback method for displaying a list of the moving image thumbnails of the video contents (the ordinary playback and the low-load playback) based on the amount of delay that is an example of the amount representing the processing load. Especially, according to the present invention, no operation by a user is necessary for playback moving image thumbnails at the ordinary playback rate of the video contents, as many moving image thumbnails as possible can be reproduced and displayed at the ordinary playback rate within limited resources and it is possible to take advantage of the simultaneous viewing without losing the properties of collective viewing and visibility. Even when the information on display time of a moving image frame is rewritten in the decoding process associated with the change of the playback method, the synchronization between the moving image and the audio in the ordinary playback can be realized and easily viewable displays can be realized. The idea of the present invention is applicable to the case where the processing load is acquired using an item other than the amount of delay.

It is possible to quickly shift the playback method for the video contents to be reproduced preferentially to the ordinary playback without the designation by the user while suppressing the amount of throughput of the whole system necessary for displaying a list of the thumbnails of the video contents by playback the video content designated to be prioritized at the ordinary rate regardless of the playback method for the displaying a list, and thereby, it is also possible to provide a viewing environment that the user can easily grasp the content of the video contents and can easily find user's favorite video contents. The video contents designated to be prioritized are displayed by properly switching among each other and, at this time, for example, a highlight of a video content is designated as an exaggeration section of the control information. Thereby, a point for viewing is guided for the user, the user can easily grasp the content of the video content, and the user can easily select user's favorite video contents. A viewing environment can be provided for the user where the user can easily and intuitively access user's favorite video contents.

The various examples have been described for the process of displaying a list of the moving image thumbnails in the video content playback apparatus according to the present invention. However, the video content playback apparatus only has to be adapted to select a favorite one of a plurality of the moving image thumbnails displayed by displaying a list of them and, thereby, reproduce the original video content of the one moving image thumbnail from the start thereof. The video content playback apparatus can be adapted to manage the components necessary for this playback using the data acquiring portion 11, the stream processing portion 12, the moving image decoding portion 13, the image output portion 15, the audio decoding portion 16, the audio output portion 17, and the control portion 18 of FIG. 1.

As above, the video content playback apparatus according to the present invention can be said to be an apparatus that, when displaying a list of the moving image thumbnails, determines, for each moving image thumbnail (that is, each video content), which playback mode is executed, the ordinary playback to reproduce the thumbnail at the display rate of the original video content, the slow playback to reproduce the thumbnail at a display rate that is lower than that of the original video content, and the skipping playback to reproduce the thumbnail partially skipping the frames of the original video content, based on the amount of delay of the playback process, and executes the playback process according to the determination result. Forcible omission of the decoding process for the slow playback and the skipping playback may be unnecessary depending on the specification of the apparatus. As above, the video content playback apparatus can also be adapted to execute the playback process in the ordinary playback (at the ordinary playback rate) synchronizing the audio therewith regardless of the amount of delay for one moving image thumbnail of a plurality of the moving image thumbnails a list of which is displayed. This adaptation becomes beneficial by incorporating the apparatus especially in a mobile telephone, a mobile information terminal, or a television device.

The purpose of the present invention is also achieved by supplying to the apparatus a recoding medium having recorded thereon a program code of the software to realize the functions in the various exemplary configurations and causing a microprocessor (or DSP (Digital Signal Processor) to execute the program code. In this case, the program code itself of the software realizes the functions of the various exemplary configurations and, therefore, the program code itself and the recording medium having recorded thereon the program code also constitute the present invention.

As described with reference to the drawings depicting the processing procedures, the present invention can also employ the form of a control method for the video content playback apparatus to display a list of the moving image thumbnail for each of a plurality of the video contents. The program code itself is, in other words, a program to cause a computer to execute the control method.

Simply describing, the control method includes an acquiring step, a moving image decoding step, a decoding control step, and an output step. At the acquiring step, a moving image stream data and time information indicating the scheduled time concerning the displaying or the decoding of the moving image stream data are acquired from the stream data of the video content a list of whose moving image thumbnail is displayed. At the moving image decoding step, the moving image stream data acquired at the acquiring step is decoded and, thereby, a moving image frame for the moving image thumbnail is acquired and the amount of delay at the end of decoding with respect to scheduled time indicated by the time information is calculated. At the decoding control step, the decoding operation at the moving image decoding step is controlled based on the amount of delay. At the output step, the moving image frame acquired at the moving image decoding step is output being adjusted based on the display time information. At the decoding control step, whether any delay is existing is determined in each video content based on the amount of delay. The decoding operation at the moving image decoding step is controlled in the ordinary playback mode for the video content for which it is determined that no delay is existing, and in controls the decoding operation executed by the moving image decoding portion the slow playback mode or the skipping playback mode for the video content for which it is determined that any delay is existing. Applications as described for the video content playback apparatus can be applied to other practical applications and, therefore, the other practical applications will not be described again.

The present invention has been described. However, the video content playback apparatus, the control method therefor, the program therefor, and the recording medium therefor of the present invention are not limited to the embodiments and it is obvious that various changes can be made thereto without departing from the gist of the present invention.

According to the present invention, when a video content playback apparatus displays a list of moving image thumbnails for a plurality of video contents, the video content playback apparatus needs no operation by any user to reproduce the moving image thumbnails at the ordinary playback rate of the video contents and, therefore, as many thumbnails as possible can be reproduced and displayed at the ordinary playback rate using limited resources.

1. A video content playback apparatus to display a list of moving image thumbnails for a plurality of video contents, comprising:
a stream processing portion that acquires a moving image stream data and time information indicating a scheduled time concerning displaying or decoding of the moving image stream data from a stream data of the video content whose moving image thumbnail is displayed in a list;
a moving image decoding portion that acquires a moving image frame for the moving image thumbnail by decoding the moving image stream data acquired by the stream processing portion, and calculates an amount of delay at the end of decoding with respect to the scheduled time indicated by the time information;
a decoding control portion that controls a decoding operation executed by the moving image decoding portion based on the amount of delay; and
an image output portion that outputs the moving image frame acquired by the moving image decoding portion while adjusting the outputting based on the time information, wherein
the decoding control portion determines whether any delay is existing in each video content based on the amount of delay, and controls the decoding operation executed by the moving image decoding portion in an ordinary playback mode that decodes a whole input moving image stream data for a video content for which it is determined that no delay is existing, and controls the decoding operation executed by the moving image decoding portion in a slow playback mode that decodes with a decoding processing amount per unit time that is lower than that of the ordinary playback mode, or in a skipping playback mode that decodes only a part of an input moving image stream data for a video content for which it is determined that any delay is existing.

2. The video content playback apparatus as defined in claim 1, further comprising
a setting portion that sets a video content to which a decoding process for a moving image thumbnail thereof, is given prior to any of a plurality of video contents, wherein
the decoding control portion controls the decoding operation executed by the moving image decoding portion in the ordinary playback mode for the video content that is set to be prioritized by the setting portion regard less of the amount of delay.

3. The video content playback apparatus as defined in claim 2, further comprising
an audio decoding portion that decodes an audio stream data, wherein
the stream processing portion acquires an audio stream data corresponding to the moving image steam data in accordance with the time information of the moving image frame acquired by decoding the moving image stream data on the moving image decoding portion for the video content that is set by the setting portion to be prioritized, and supplies the audio stream data to the audio decoding portion.

4. The video content playback apparatus as defined in claim 1, wherein
the moving image decoding portion changes the time information that corresponds to a moving image stream data to which the decoding process is given, according to a playback mode determined by the decoding control portion or depending on the amount of delay.

5. The video content playback apparatus as defined in claim 3, wherein
the video content playback apparatus executes a playback process for one moving image thumbnail of the plurality of moving image thumbnails to be displayed in the list in ordinary playback synchronizing the playback process with an audio regardless of the amount of delay.

6. A control method in a video content playback apparatus to display a list of moving image thumbnails for a plurality of video contents, including:
an acquiring step of acquiring a moving image stream data and time information indicating a scheduled time concerning displaying or decoding of the moving image stream data from a stream data of the video content whose moving image thumbnail is displayed in a list;
a moving image decoding step of acquiring a moving image frame for the moving image thumbnail by decoding the moving image stream data acquired at the acquiring step, and calculating an amount of delay at the end of decoding with respect to the scheduled time indicated by the time information;
a decoding control step of controlling the decoding operation at the moving image decoding step based on the amount of delay; and
an output step of outputting the moving image frame acquired at the moving image decoding step while adjusting the outputting based on the time information, wherein
at the decoding control step, whether any delay is existing is determined in each video content based on the amount of delay, and the decoding operation at the moving image decoding step is controlled in an ordinary playback mode that decodes a whole input moving image stream data for a video content for which it is determined that no delay is existing, and controls the decoding operation at the moving image decoding step in a slow playback mode that decodes with a decoding processing amount per unit time that is lower than that of the ordinary playback mode, or in a skipping playback mode that decodes only a part of an input moving image stream data for a video content for which it is determined that any delay is existing.

7. The control method as defined in claim 6, further including
a setting step of setting a video content to which the decoding process for a moving image thumbnail thereof, is given prior to any of a plurality of video contents, wherein
at the decoding control step, the decoding operation at the moving image decoding step is controlled in the ordinary playback mode for a video content that is set to be prioritized at the setting step regard less of the amount of delay.

8. The control method as defined in claim 7, further including:
a step of acquiring an audio stream data corresponding to the moving image steam data in accordance with the time information of the moving image frame acquired by decoding the moving image stream data at the moving image decoding step for the video content that is set at the setting step to be prioritized; and
an audio decoding step of decoding the audio stream data.

9. The control method as defined in claim 6, wherein
the moving image decoding step includes a step of changing the time information that corresponds to the moving image stream data to which the decoding process is given, according to a playback mode determined at the decoding control step or depending on the amount of delay.

10. The control method as defined in claim 8, wherein
a playback process for one moving image thumbnail of the plurality of moving image thumbnails to be displayed in the list is executed in ordinary playback synchronizing with an audio regardless of the amount of delay calculated at the calculating step.

11. A program for executing the control method as defined in any one of claims 6 to 10 on a computer.

12. A recording medium having the program as defined in claim 11 recorded computer-readably thereon.
